(19) United States
(12) Patent Application Publication
(10) Pub. No.: US 2001/0020141 A1
(43) Pub. Date: Sep. 6, 2001

(54) METHOD OF RESTORING SPEECH FUNCTIONS IN PATIENTS SUFFERING FROM VARIOUS FORMS OF DYSARTHRIA, AND DYSARTHRIA PROBES

(76) Inventor: ELVINA IVANOVNA CHAHINE, CHICAGO, IL (US)

Correspondence Address: ANDERSON KILL & OLICK,PC, 1251 AVE OF THE AMERICAS, NEW YORK, NY, 10020-1182, US

(21) Appl. No.: 09/066,317

(22) PCT Filed: Apr. 23, 1996
(86) PCT No.: PCT/RU96/00097

§ 371 Date: None

(30) Foreign Application Priority Data
Oct. 31, 1995 (RU) 95117984

(51) Int. Cl. A61H 1/00

(52) U.S. Cl. 601/46

(57) ABSTRACT

A method for restoring speech functions in patients having various forms of dysarthria by way of successively carrying out the cosmetic massage of the face, the point massage of biologically active points of the face, cervical-collar region, arms and articulation organs, articulation-mimic gymnastics followed by voice exercises. The point massage is carried out by successively pressing, pricking, stroking for 1-5 seconds 3-5 times for 3-5 points, by sequentially alternating same and by adding 1-2 points. Pair points are massaged with two probes simultaneously.

Dysarthria probes for carrying out a method for restoring speech functions by way of exerting a reflex action on the patient's biologically active points, which comprise a rod and an operating part whose configuration is varied in relation to the patient's clinical profile, for example, in the form of a ball, a sphere, an oval, a two-prong unit or a three-prong unit.

The operating parts of the probes are made of ebonite, copper, titanum and/or stainless steel and can be dismantled.

### TECHNICAL FIELD

The invention relates to medicine, more specifically to treatment of speech disorders, e.g. various forms of dysarthria.

### PRIOR ART

Defects of pronunciation in case of dysarthria are due to the organically insufficient innervation of organs of speech most frequently as a result of paresis and the muscular paralysis of articulation organs. Characteristic for dysarthria is a limited mobility of speech organs: the soft palate, tongue and lips because of affection of muscles.

Very popular in practical medicine are methods for normalising a patient's speech, which include the preliminary examination of the patient and the subsequent mimic muscle gymnastics, teaching the patient how to pronounce syllables using pedagogic methods and also elements of breathing exercises (cf. The book by F. A. Rau et al. “Methods of teaching deaf-mutes to pronounce”, 1948, Uchpedgiz, Moscow, page 178).

Known in the art is a device for a mechanical effect exerted on the tongue in training and correcting the pronunciation of certain sounds of speech in the case of some forms of speech disorders, which comprises a handgripportion and a working member. This device (logopedics probe) performs the function of an auxilary technical means in some cases to assimilate articulation required and does not contribute to normalizing the muscle tone. The use of logopedics probes leads to a quick fatigue of speech therapeutist's hands because of the inconvenient use of probes (when placed in the patient's mouth) in consequence of a change in the structure of petient's articulation organs and requires the speech therapeutist's great efforts. Besides, the logopedics probes are mainly used in training sounds to adjust vocal organs in a position of pronunciation in case of tongue-tie, lateral and sibilant sigmatisms, dental and interdental sigmatisms and also when working with deaf-mutes (cf. Defectologicheskii Slovar, 1970, Pedagogika Publishers, Moscow, page 122).

Known is a kit of the type used for exerting a reflex action on points and regions in case of affected supporting-motorial organs, bronchial asthma, neuralgias, joint formations, which comprises a casing accommodating at least three probes whose operating parts are embodied in the form of streamline mushroom elements and a tapering rod. This kit does not enable one to perform point action on the biologically active points of the articulation organs and to achieve a desired effect when exerting action on the biologically active points of the face, arms and the cervical-collar region, which is necessary to realize modem speech therapy methods (cf. RU 2034528, 1995).

As can really be seen from the afore-said, persons skilled in the art possess a small number of steps for correcting speech defects, directed, as a rule, to correcting pronunciation and speech breath.

Also, speech therapy resides in narrow training exercises to be done along with the other medical procedures.

At the same time, conventional methods for removing speech defects cannot satisfy needs of medicine in full, because these do not possess a required complex of properties to enhance the efficiency of tretment.

### DISCLOSURE OF THE INVENTION

It is the principal object of the present invention to provide an integrated approach to the problem of restoring speech functions in patients suffering from various forms of dysarthria.

The integrated approach consists in working out a method of restoring speech functions in patients with such disturbances and in developing a kit of dysarthria probes enabling one to perform the point massage of biologically active points whose configuration of operating members is varied in relation to the patient's clinical profile. The task set is solved owing to the fact that the muscle tone of articulation organs is normalized through the all-out method of restoring the speech functions of articulation organs, with the use of probes for the point massage of biologically active points, action on which, according to a certain diagram, results in stimulating the nervous ends and muscles associated with biologically active points. Stimulation is attained by pressing, pricking (to cause or to restore sensitivity that is lowered or absent in patients) and stroking actions to be advantageously exerted by different probes. Action is made by retarding or an exciting method. The configuration of the operating members of probes is varied and dictated by the demands of effects exerted by the speech therapeutist, which are established in relation to the clinical profile by the speech therapeutist himself.

The probes are made of various materials having good conductive and electromagnetic properties—ebonite, titanium, stainless steel, copper and can, for example, be made from plastic material, glass, rock crystal. In case of retardation action it is advisable to use ebonite probes and metallic ones—in excitation. All the probes have well polished surfaces.

### BRIEF DESCRIPTION OF DRAWINGS

The invention is explained by the drawings:

FIGS. 1-13 show the certain diagrams of an effect exerted by point massage on the biologically active points of the face, cervical-collar region, arms, patient's tongue, throat.

FIGS. 14-33 show the different designs of dysarthria probes: straight, ones with a curvature in the form of a massage thrust step, probes with operating parts in the form of two-prong units, three-prong units, spherical thickenings and rings one of which has acicular inner projections.

### BEST MODE OF CARRYING OUT THE INVENTION

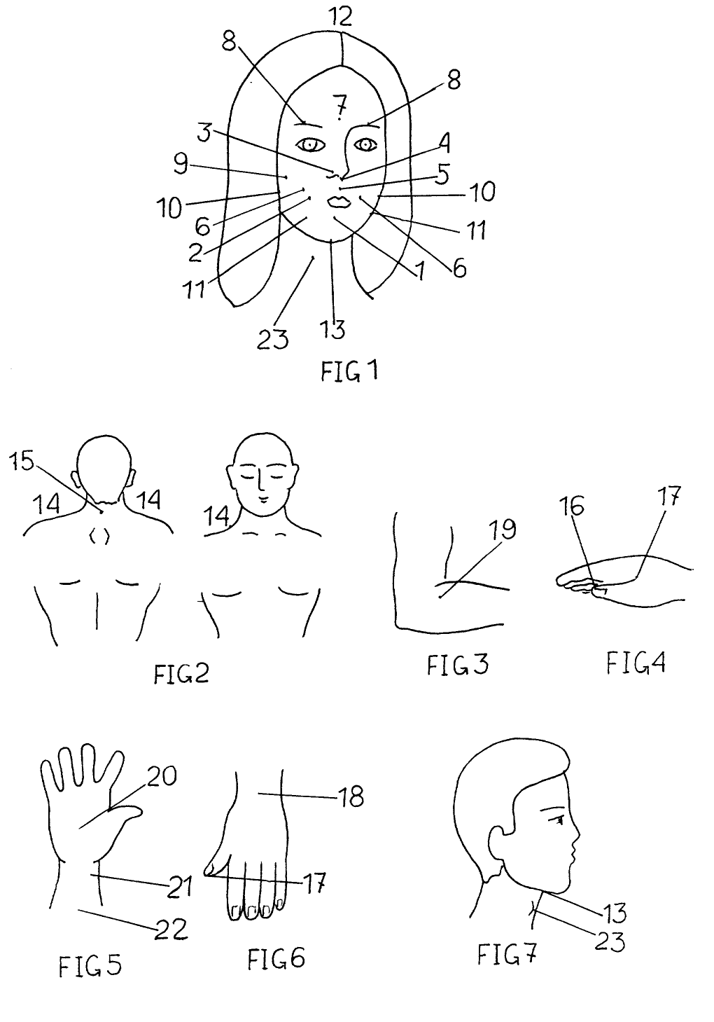

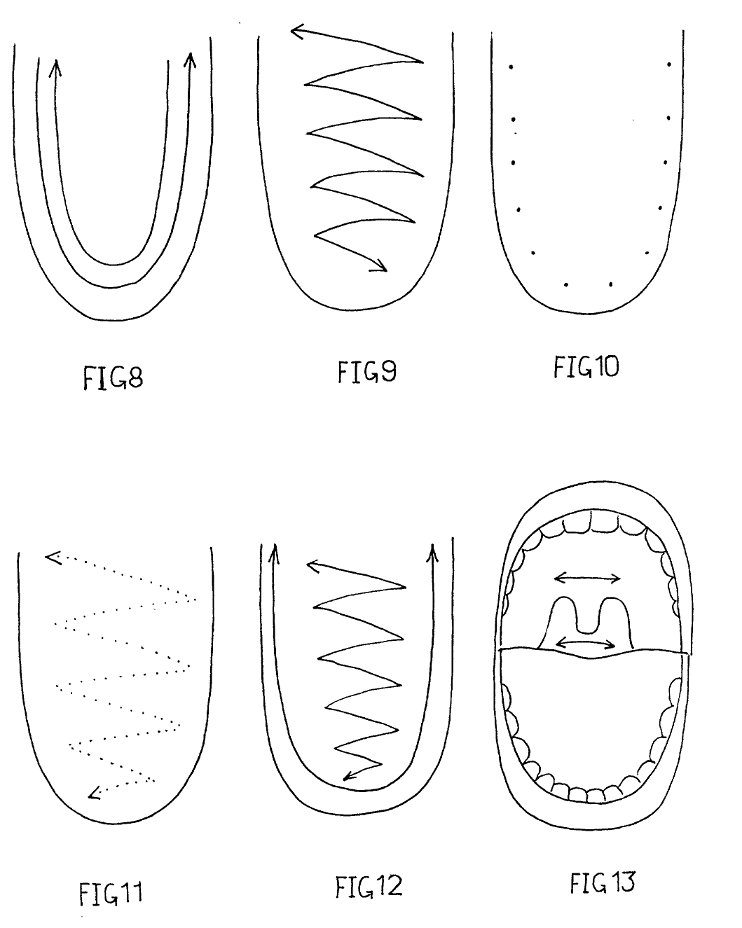

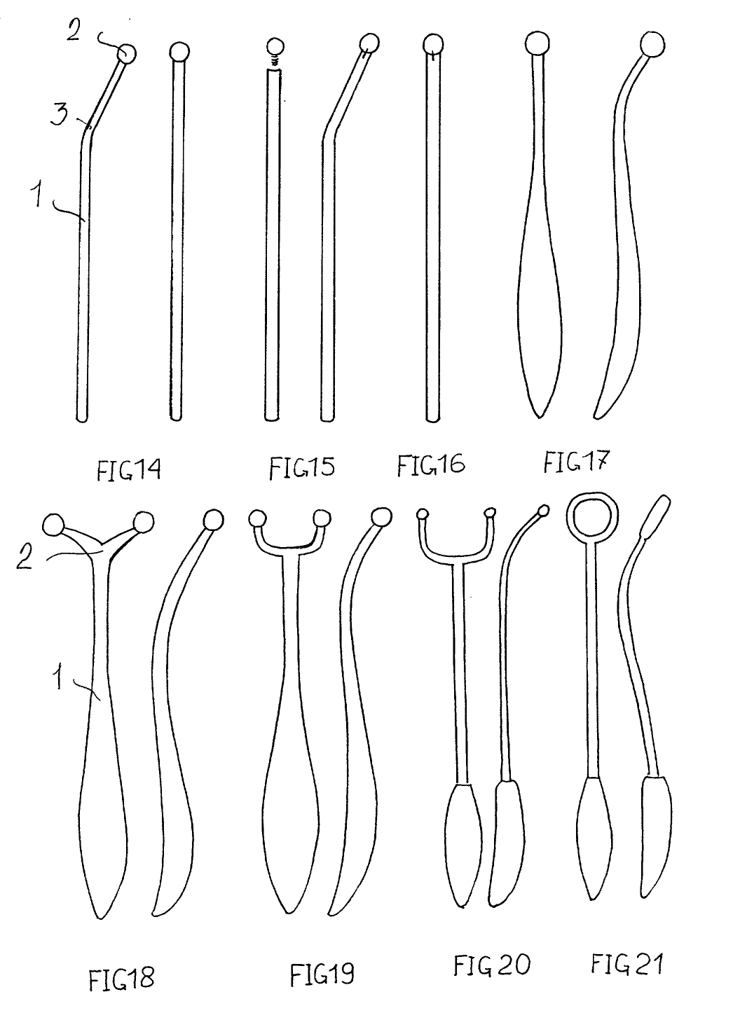

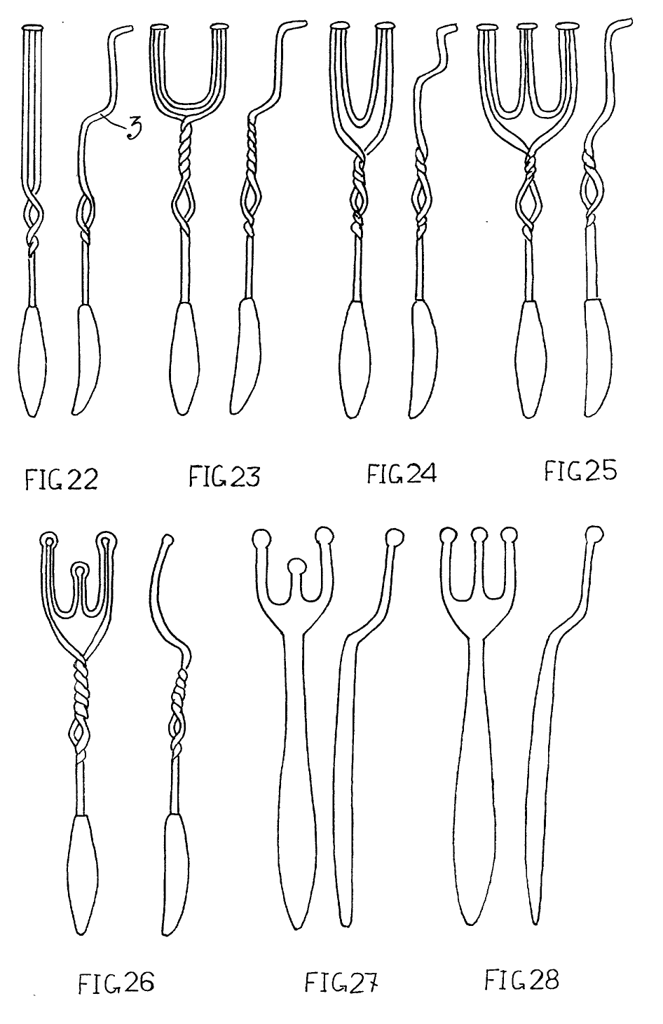

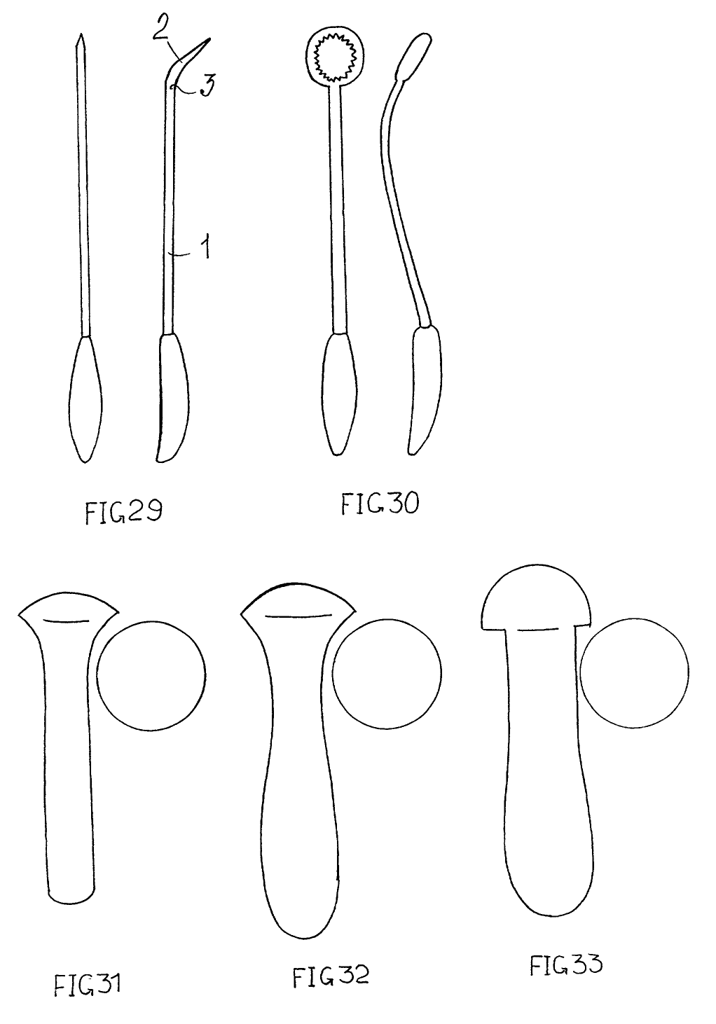

The method is carried out in the following manner. A patient is seated in a chair in a convenient posture and the cosmetic massage is done his/her face by the fingers of speech therapeutist's hands. Clothes are then removed from the body's parts liable to point massage is done on the biologically active points of the face and the cervical-collar region. The points for action and an instrument are chosen according to special methods, for which purpose a probe with an operating part in the form of a ball-like head acts first upon point 1 (FIG. 1) in a recess in the chin, followed by a two-prong unit pressing pair points 2 which are situated near the corners of the mouth, repeating the action on the same points by pricking, using a probe having an operating part in the form of a needle (FIG. 29).

Pressing and pricking procedures are then carried out in succession for other ten facial points as well(FIG. 1). Exposure for each and every point is 1-5 seconds and action is repeated 3-5 times by way of pressing, pricking and stroking. 3-5 points are acted upon in a single procedure and 1-2 points are added thereto.

At the end of the procedure, facial massage is carried out with the aid of the handgrip portions of ebonite probes (FIGS. 17, 18) or a probe in the form of a little mushroom (FIGS. 31-33) on the massage lines from the center of the chin to the ears.

On massaging the cervical-collar region,. acted upon are first points 13 and 23 (FIG. 1) and preferable thereat is the use of a probe in the form of a little mushroom, by sequentially pressing points 12, 14 and 15, using the same probe. After this points 16, 17, 12, 18, 20, 21, 22 are stimulated by a probe with a ball-like head and then by one in the form of a needle (FIG. 29).

Exposure lasts 1-5 seconds 4-5 times. Points 20, 21, and 22 are activated in cases when there is paresis of an arm.

On massaging the arms, acted upon are points 14, 16, 17, 18 and 19 according to the above-mentioned diagram. The points of articulation organs are massaged in several stages. First affected are points disposed on the tongue according to the diagram shown in FIGS. 8-12, then beneath the tongue, on the palata curtain, the uvula and on the rear wall of the phrynx (FIG. 13).

On massaging the patient's tongue, he/she is seated before a mirror, a probe (FIG. 17) is placed on the surface of the tongue by the right edge of its root, with the end portion having a ball-like massage element, the probe is led on the surface of the tongue's edge clockwise and counterclockwise 3-4 times for 3-5 seconds. Movements are carried out according to FIG. 8, the tongue is pricked around (FIG. 29) according to FIG. 10 and the tongue is then stroked along the same lies. All the procedures are carried out in 3-5 seconds 2-4 times. The point in the middle of the tongue is pressed (FIG. 26), pricked around (FIG. 29) and stroked by the probe (FIGS. 17, 18) from the root to the tip and back. Exposure: 5-7 seconds, action is repeated 3-5 times.

Sublingual massage is carried out by probes (FIGS. 18, 19, 26, 27, 28). The lower surface of the tongue is laid onto the surface of the probes, pressing the points by their massage elements which are disposed beneath the tongue and, along with this, the middle prong of the probe (FIGS. 26, 27, 28) is set onto the anterior lower teeth, the tongue is raised a little by the probes and the lower surface of the tongue is stroked by the same probes.

The enumerated probes are helpful in stretching the frenulum of tongue in children whereby to avoid surgial intervention as in the case with the shortened frenulum.

Exposure lasts 3-5 seconds, action is repeated 3-5 times. For the palate curtain to be massaged, use is made of probes (FIGS. 14, 15, 16, 17, 18, 19, 29), the horizontal part of a probe's operating member is arranged on the surface of the tongue, the tongue's root is fixed by a probe's massage thrust step, it is then released, thus lowering and stimulating the palate curtain. The procedure is repeated 3 times for 3-7 seconds.

With onesided paresis, use is made of a probe (FIGS. 22, 23, 24) that is placed onto the immobile side of the tongue and a similar action is performed. In case of ⅔ of the tongue being affected by paresis, use is made of the probe (FIGS. 23, 24, 25). It is possible to use probes to fix the tongue with the aid of a ball-like thickening (FIGS. 14, 15, 16, 17) acting upon the palate curtain.

On massaging the uvula, use is made of a probe (FIG. 21) that is set on the uvula with its annular portion, movements being performed from bottom to top and back. The same procedure is then carried out by a probe (FIG. 30). Use is also made for the same purpose of probes (FIGS. 14, 15, 16, 17, 30). The uvula is pricked around by the probe as well (FIG. 29).

For the points of the rear wall of the pharynx to massaged by a probe (FIGS. 22, 23, 24, 25), the tongue is pulled and the rear wall of the pharynx is stroked by the probe (FIGS. 14, 15, 16, 17) counterclockwise, using a ball-like thickening. 3-5 minutes after, articulation-mimic exercises are done on the patient with the aim of developing a force, volume and reversibility of movements of the muscles of the speech organs, accuracy and purposefulness of movement. And gymnastics may be whatever desired as to steps (procedures) and necessarily directed to providing the functions prescribed.

Articulation gymnastics includes exercises for cheeks, lip muscles, mandible, soft palate muscles, lips, mimic exercises of the face and eyes.

3-5 minutes after, breathing exercises are done to differentiate the oral and nasal breathing and to achieve a prolonged and smooth oral expiration under the control of movement of the diaphragm and the abdominal muscles. Gymnastics may be whatever desired to contribute to the aforesaid result. The general course of treatment is 45 days of daily seances with a repetition of said course of treatment 6 months after to secure an effect obtainable in case of a heavy form of dysarthria.

FIGS. 14-13 show a kit of dysarthria probes, which comprises a straight probe with a rod I and an operating part 2 in the form of a ball-like thickening (FIG. 16), a probe with a curvature in the form of a massage thrust step 3, having an operating part with a transverse end (FIG. 22), the additional groups of probes with operating parts 2 in the form of two-prong units (FIGS. 18, 19, 20), probes with the ball-like thickenings and ones with the rings being curved at an angle of 25°-45°, in the form of a rod (FIG. 22), a probe with a three-prong unit (FIG. 25) and part of probes of a group with two-prong units (FIGS. 23, 24) having curvatures in the form of a massage thrust step, the tapering rod configured as the needle 2 (FIG. 29), and the maximal cross-sectional area of each mushroom-like element (FIGS. 31, 32, 33) exceeding at least twice the cross-sectional area of each and every ball-like thickening.

Made from ebonite are probes represented in FIGS. 17, 18, 19, 27, 28, 31, 32, 33. From metals (copper, or titanum, or stainless steel)—probes shown in FIGS. 14, 15, 16, 17, 26, 29, 30 having detachable ball-like thickenings. The ball-like thickenings are globular or oval. The probes with an operating part in the form of a two-prong unit (FIGS. 18, 19, 20), a three-prong unit (FIGS. 27, 28) have ball-like thickenings, provided on the faces of the operating part, in the form of a sphere or an oval. The probes with operating parts in the form of three-prong units (FIGS. 26, 27) have lateral prongs exceeding a middle prong or equal to it lengthwise (FIGS. 25, 28). The operating part of the probes represented in FIGS. 26-28 is oriented at an angle of 20° to 25°. The ball-like thickenings of the probes are oriented at an angle of 40° to 45° to the longitudinal axis. The faces of the operating parts of two-prong and three-prong units made of ebonite have ball-like thickenings in the form of a sphere or an oval. The straight probe (FIG. 22) and the probes with the operating parts in the form of two-prong and three-prong units (FIGS. 23-25) have the recurved ends of a plane oriented transversely of the operating part. The probes with operating parts in the form of a stream-lined mushroom element (FIG. 31) are made cylindrical and from FIG. 33—tapering towards the center.

The angle between the prongs of an ebonite probe with an operating part in the form of a two-prong unit (FIG. 18) is obtuse, or right, or acute. The inner surface of the operating part of the ebonite probe in the form of the two-prong unit is configured as a semicircle (FIG. 19), U-shaped (FIG. 20). The through probe and probes with operating parts in the form of rings, two-prong units, three-prong units have handgripportions and connected with the grips for joint. A kit may contain a container, or a sheath, or a box for set of probes (not shown on the drawings).

In the case of ebonite probes used for massaging the cervical-collar region, arms and face, use can be made of both ends as operating ones (FIGS. 31, 32, 33). They have a stream-lined mushroom shape, the cylindrical shape of a rod (FIG. 31), a tapered handgripportion towards the middle(FIG. 33) or towards the operating part with a maximal cross-section (FIG. 32). The shape of a grip of this type of probes is dictated by a convenient action produced on biologically active points and the possibility of a force required and sufficient for producing the action.

The use of probes of all the constructions contributes to conveniently arranging their massaging elements and them proper in difficultly accessible places in the patient's mouth in performing point massage operations as a result of a change in the structure of articulation organs, the possibility to create a sufficient force for acting on biologically active points. In case of tongue hyperkinesia, use is made of probes with an additional fixing portion of steped form (FIGS. 22-25) which makes it possible to reliably retain the tongue by the probe and does not interfere with the point massage of biologically active points.

The ebonite grips of probes have a smooth polished surface and serve as an auxiliary massage instrumentfor the face and cervical-collar region. All the probes are convenient in operation and do not cause fatigue when used by speech therapeutists.

A course of restoring speech functions in patients suffering from various forms of dysarthria includes a complex treatment by the successively performed cosmetic massage of the face, point action exerted by dysarthria probes of different configuration on the biologically active points of the face, cervical-collar region, arms and articulation organs, articulation-mimic and breathing exercises and restoration of speech/voice characteristics.

### MODES OF CARRYING OUT THE INVENTION

### EXAMPLE 1

Patient S., 26, admitted to the speech department of a daytime hospital, diagnosis: pseudobulbar spastic rigidity dysarthria.

A volume of movement of the tongue, lips and the jaw increased on the third day of treatment.

A tempo of speech accelerated on the seventh day of treatment, the lips became more mobile, the tongue began to rise up. The articulation—mimic mobility of muscles improved.

On the 15th day the tip of the tohgue began vibrating, the patient began pronouncing the sound “r”. The restoration training resulted in positive dynamics: speech breath considerably improved, speech expiration prolonged, timbre improved, the voice became more modulated.

### EXAMPLE 2

Patient E., 24, diagnosis: infantile cerebral paralysis, dysarthria of spastic-paretic form. Speech therapy examination: the amimic face, increased salivation. Restricted scope of movements of the tongue, lips, insufficient amplitude of movements. Movements are performed in slow tempo, quickly exhausted; the tone of tongue muscles enhanced. Speech pronounciation aspect: reduced vowels, indistinct, unclear sibilants replaced with dental sounds, speech intelligibility reduced because of a phonetic defect. Vocabulary of household words, phrase speech not formed. Superficial speech breath; short, weak expiration; an expiration force quickly exhausted in a speech flow, turns into speech on taking breath. Voice: sonorous, loud cry. Speech phonation: weak dull, monotonous, nasalized, exhausted; speech: toneless, with no melodical tint.

A complex treatment, as proposed, was used. Positive dynamics was observed. A considerable improvement in the state of pronouncing aspect of speech, pronounciation of sounds improved as is a prosodic shaping of utterances. Nasalized speech tint removed, speech tempo advanced. The hyperkinetic manifestations in the articulation organs disappeared, salivation diminished.

The muscles of articulation organs became less constrained as the result of point massage, with the use of dyarthria probes, their movements became more purposeful and accurate. The aim was to achieve unhurried speech tempo (easy articulation).

### EXAMPLE 3

Patient I., 23, diagnosis: childbirth aftermath, subcortical dysarthria. Speech therapy examination: enhanced salivation, restricted scope of movements of the tongue and lips. Enhanced tongue tone. The pronouncing aspect of speech: articulation of vowels disturbed more than the consonants. Individual words and sounds can be pronounced correctly but at the moment of hyperkinesia theseturn out to be much distorted and unintelligible. The tempo, rhythm and melodics of speech upset. Voice constrained, sharp, hoarse, ranging in timbre and loudness. Sometimes voice “dies out”, as it were, turning into a whisper.

A complex method of treatment was used. Positive dynamics after a course of treatment: a marked improvement of the pronouncing aspect of speech. Hyperkinetic manifestations in the muscles of articulation organs disappeared. At the same time there are some defects in pronunciation of sounds, more specifically, fricative sounds and affricates, insufficient expressiveness of utterances (intonation), speech scanned and retarded somewhat.

These results have been achieved by way of regular logopedic exercises with the use of point massage and dysarthria probes, which are directed to “mastering” each and every component of speech act associated with pronunciation (breathing, vocal formation, articulation).

Upon completion of the second course of treatment of the patient, a further regression was observed of dysarthria symptomatology, an isolated pronouncing of all the sounds except for sibilants and “r”, normally, which require correction.

The muscles of organs participating in articulation became less constrained as the result of point massage, movements became more purposeful and accurate.

Reversibility improved from one articulation movement to another. A correct articulation usage of the sounds “s”, “z”, “ts”, “sh”, “zh”, “ch”, “l”, “t”, “d” assimilated. The sounds automated, differentiated in syllables, words, sentences, verses, tongue-twisters, proverbs. The aim is an unhurried speech tempo (easy articulating). The pronouncing side of speech corrected during signing, reading. Articulation of some sounds made more accurate in the words.

The method approbated on 94 patients, with prevalence of an average and heavy degree of dysarthria, with the pronounced pareses and coarse speech disturbances at the age of 15 to 60, a duration of illness of from 3 months to 7 years. The clinical effectiveness of treatment by the proposed method, using the dysarthria probes, is shown in Table 1.

TABLE 1

| | Number of patients, absolute and in % | |
|---|---|---|
| Clinic | use of dysarthria probes | classic |
| effectiveness | in point massage | speech therapy |
| Considerable improvement | 23 (21.62%) | 15 (15%) |
| Improvement | 66 (62.04%) | 30 (30%) |
| Inconsiderable improvement | 2 (1.88%) | 7 (7%) |
| No changes | 1 (0.94%) | 42 (42%) |
| Changes for the worse | — | — |
| Total | 94 (100%) | 100 (100%) |

The complex treatment of restoration of the speech functions in patients suffering from dysarthria—cosmetic massage, articulation-mimic and breathing exercises, stimulation of biologically active points of the face, cervical-collar region, arms and articulation organs normalizes the musclar tone and restores the patient's speech functions.

The proposed complex method of treament can reduse the time of treatment up to 45 days, compared to traditional treatment of this deseases that lasts for years. The number of invalids suffering from serious dysarthria forms and cured by the proposed method is sharply reduced, the patients return to a nolmal way of life and work.

### Industrial Applicability

The proposed invention will find an effective application in hospital conditions in curing patients having different dysarthria heaviness and also children suffering from infantile cerebral paralysis, in case of obliterated dysarthria form.

1. A method for restoring speech functions in patients suffering from various forms of dysarthria, comprising the steps of doing articulation and breathing exercises, which method is characterized in that before articulation and breathing exercises successively performed are the cosmetic massage of the face, the point massage of biologically active points of the face, cervical-collar region, arms and articulation organs, articulation-mimic gymnastics followed by breathing exercises under the control of movement of the diaphragm and abdominal muscles, with the tongue, lip and cheeks adjusted in a pronounciation position and voice exercises performed on expirationwhich improve pronouncing speech performance in the form of syllable pronounciation, tempo, rhythm, melodics, smoothness, voice, modulation, timbre.

2. The method of claim 1, characterized in that point massage is carried out by sucsessively pressing, pricking, stroking by the probes for 1-5 seconds 3-5 times for 3-5 points, by sequentially alternating the points and by adding 1-2 points.

3. The method of claim 2, characterized in that pair points are massaged by two probes simultaneously.

4. A dysarthria probe for exerting a reflex action on the patient's biologically active points, comprising an operating part in the form of streamline mushroom elements and a tapering rod, which probe is characterized in that the probe's operating part is configured as a ball-like thickening (2) with a curvature in the form of a massage thrust step (3), which has an operating part with a transverse end portion.

5. A dysarthria probe characterized in that its operating part (2) is made as two-prong units, or three-prong units, or ball-like thickenings angularly oriented to the longitudinally extending axis of the probe, or mushroom-shaped elements, or rings, of which one has internal acicular lips and the operating parts of the probe are curved at an angle to the axis of the rod.

6. A dysarthria probe of claims 5, characterized in that it has curves (3) in the form of a massage thrust step and the tapering rod ends in the needle.

7. A dysarthria probe of claim 4,5, characterized in that the operating parts (2) in the form of a ball-like thickenings, two-prong units, three-prong units are made from ebonite, or copper, or titanum, or stainless steel and have handgripportions.

8. A dysarthria probe of claim 5, characterized in that the operating part (2) in the form of a two-prong unit is made from metal and provided with the ball-like thickenings at the ends of the operating part, in the form of a sphere or an oval.

9. A dysarthria probe of claim 5, characterized in that the operating part (2) in the form of three-prong units has lateral prongs being equal to or exceeding the central prong lengthwise and the ball-like thickenings are spherical or oval.

10. A dysarthria probe of claim 9, characterized in that the operating part is oriented at an angle of 20 to 25°.

11. A dysarthria probe of claim 4, characterized in that the ball-like thickenings are oriented at an angle of 40 to 45° to the longitudinal axis of the rod.

12. A dysarthria probe of claim 5,6, characterized in that the ends of operating parts of the two-prong units and three-prong units are made from ebonite.

13. A dysarthria probe of claim 4,5, characterized in that the operating part in the form of two-prong units or three-prong units has recurved ends in a plane being transverse to its operating part.

14. A dysarthria probe of claim 5, characterized in that the operating part (2) in the form of streamlined mushroom-shaped elements smoothly merges with the cylindrical rod.

15. A dysarthria probe of claim 9, characterized in that the operating part (2) in the form of streamlined mushroom-shaped elements smoothly tapers towards the middle of the rod.

16. A dysarthria probe of claim 5,12 characterized in that the angle between the prongs of the operating part in the form of a two-prong unit of ebonite is obtuse, or right, or acute while the inner surface of two-prong unit is made a semicircle or V-shaped.

17. A dysarthria probe of claim 4,5, characterized in that the operating part (2) is made removable.
